(19) United States
(12) Patent Application Publication
(10) Pub. No.: US 2015/0173872 A1
(43) Pub. Date: Jun. 25, 2015

(54) REPLACEABLE MULTI-DIRECTIONAL BRUSH HEAD FOR A TOOTHBRUSH AND A METHOD OF USING THE SAME

(71) Applicant: BRUSHPOINT INNOVATIONS INC, King City (CA)

(72) Inventor: Robert G. Dickie, King City (CA)

(73) Assignee: BRUSHPOINT INNOVATIONS INC, King City (CA)

(21) Appl. No.: 14/138,849

(22) Filed: Dec. 23, 2013

(51) Int. Cl. A61C 17/22; A61C 17/32

(52) U.S. Cl. CPC A61C 17/222; A61C 17/32

(57) ABSTRACT

A brush head including a housing, detachably securable to a handle of a powered toothbrush. A camshaft extends through a cavity defined in the brush head. The camshaft is operatively engaged with a motorized drive shaft in the handle and causes independent movement in tuft blocks provided on a head region of the brush head. Bristle tufts extend outwardly from each tuft block and through an opening defined in the head region. The rotating camshaft causes a first tuft block to reciprocate linearly in a plane disposed at right angles to the longitudinal axis and causes the second tuft block to oscillate about an axis parallel to the housing's longitudinal axis. The bristles on the first block chisel particulate material from the surfaces of the teeth being cleaned; and the bristles on the second block sweep particulate material from those surfaces.

### BACKGROUND OF THE INVENTION

1. Technical Field

This invention relates general to dental hygiene products. More particularly, this invention relates to powered toothbrushes and to replaceable brush heads used in powered toothbrushes. Specifically, this invention is directed to a brush head for a powered toothbrush, where the brush head includes a plurality of tuft blocks operatively engaged with a rotatable camshaft. At least a first tuft block is caused to reciprocate linearly in a plane disposed at right angles to a longitudinal axis of the camshaft; and the second tuft block is caused to oscillate about an axis parallel to the camshaft's longitudinal axis.

2. Background Information

Electrical or powered toothbrushes have been available on the market for several years. These toothbrushes are superior to manual toothbrushes for several reasons, including the speed with which the bristles are caused to move across the surfaces of the teeth and because of the pattern the bristles follow as they move across the those surfaces. Most powered toothbrushes include bristle tuft blocks which rotate or oscillate in some manner.

U.S. RE35,941 (Stansbury, Jr.), the entire specification of which is incorporated herein by reference, discloses a powered toothbrush having a plurality of tuft blocks juxtaposed in the brush head. The tuft blocks are engaged with a camshaft which, when rotated, causes individual blocks to move linearly with respect to a longitudinal tuft axis. In other words, each of the blocks moves in an in-and-out motion with respect to an aperture within which the tuft blocks are seated. The bristles “chisel” plaque and food particles from the surfaces of the teeth because the bristles are rapidly moving substantially at right angles to the surfaces of the teeth.

U.S. Pat. No. 8,522,390 (Stoerkel et al) discloses a brush head/toothbrush which may be manual or powered. The brush head/toothbrush includes a first carrier and a second carrier mounted on opposite sides of the brush head. The second carrier is positioned underneath the first carrier and is configured for movement relative thereto. A plurality of bristles is fixedly engaged with the first carrier. The first carrier also defines a plurality of apertures therein and bristles provided on the second carrier extend through these apertures and are disposed adjacent the bristles on the first carrier. The first carrier may not be driven, i.e., it may remain in the same position relative to the elongate tube of the brush head. Alternatively, the first carrier may be driven so that it reciprocates in a longitudinal extension direction (L). The bristles on the first carrier do not move relative to the first carrier—it is the entire first carrier that moves. The second carrier is mounted in such a way that it is able to move in an oscillatory motion around a longitudinal axis (W) that is substantially parallel to longitudinal extension axis (L) of the brush head or toothbrush. This motion causes the bristles on the second carrier to wipe or sweep across the surfaces of the teeth being cleaned. (Again, the bristles are not moved relative to the second carrier, it is the entire second carrier that is moved.) The sweeping motion of the bristles of the second carrier pushes loose particles and plaque on the surface of the teeth off the same.

US Publication No. 2012/0159722 (Fritsch) discloses a brush head/toothbrush in which a cleaning section includes a cleaning element carrier mounted for oscillatory rotation about a carrier rotation axis. The bristles thus are arranged to sweep across the surfaces of the teeth being cleaned. A gear is coupled to a drive shaft extending from the handle and engages the cleaning element carrier to transfer motion from the drive shaft to the carrier.

US Publication No. 2013/0227804 (Fritsch) discloses a brush head which includes a head portion with a movable contact element holder which is caused to move relative to the head by a drive mechanism. A portion of this movable contact element holder is exposed on a back side of the brush head. Movable contact elements are supported within the movable contact element holder. The holder has a certain number of bristles affixed to it and the movable contact elements engaged in the holder have other bristles affixed to them. The holder oscillates about a longitudinal axis and the movable contact elements also oscillate about the longitudinal axis but out of synchrony with the holder. Thus, all of the bristles are oscillated about the longitudinal axis. All of the bristles are thus caused to sweep across the surface of the teeth being cleaned.

There is still a need in the art for a toothbrush which more effectively cleans the surfaces of teeth.

### SUMMARY

In one aspect, the invention may provide a brush head including a housing detachably securable to a handle of a powered toothbrush; and a powered toothbrush incorporating the brush head. The brush head is detachably engageable with the handle. A camshaft extends through a cavity defined in the brush head. The camshaft is operatively engaged with a motorized drive shaft in the toothbrush handle and causes independent movement in tuft blocks provided on a head region of the brush head. Bristle tufts extend outwardly from each tuft block and through an opening defined in one face of the head region. The rotating camshaft causes a first tuft block to reciprocate linearly in a plane disposed at right angles to the camshaft's longitudinal axis; and causes the second tuft block to oscillate about an axis parallel to the camshaft's longitudinal axis. The bristles on the first block chisel particulate material from the surfaces of the teeth being cleaned; and the bristles on the second block sweep particulate material from those surfaces.

In another aspect, the invention may provide a powered toothbrush comprising;
a handle; and
a brush head comprising:
   a housing having a head region and a shaft region, wherein the shaft region terminates in a free end configured to be secured to an end of the handle;
   a cavity originating in an aperture defined in the free end of the shaft region, said cavity extending inwardly into the head region;
   an opening defined in a front face of the head region, said opening being in communication with the cavity;
   a camshaft extending through the aperture and into the cavity along a longitudinal axis; wherein said camshaft is adapted to be operatively engaged with a drive shaft driven by a motor disposed within the handle;
   a first and second tuft block provided on the head region and operatively engaged with the camshaft and being independently movable by the camshaft;
   at least one bristle tuft extending outwardly from a face of each of the first and second blocks and extending outwardly of an opening in the head region; and wherein the first tuft block is caused to reciprocate linearly in a plane disposed at right angles to the camshaft's longitudinal axis and the second tuft block is caused to oscillate about an axis disposed substantially parallel to the camshaft's longitudinal axis.

In another aspect, the invention may provide a method of removing food matter and/or plaque from teeth; said method including:
providing a toothbrush having a brush head comprising a housing with a head region and a shaft region, a camshaft extending through a cavity defined in the housing and operatively engaged with a drive shaft driven by a motor in a handle of the toothbrush; a first and second tuft block provided on the head region and being operatively engaged with the camshaft, and at least one bristle tuft extending outwardly from a face of each of the first and second tuft blocks;
rotating the camshaft about a longitudinal axis;
linearly reciprocating the first tuft block in a plane disposed at right angles to the camshaft's longitudinal axis; and
oscillating the second tuft block about an axis disposed substantially parallel to the camshaft's longitudinal axis.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims.

FIG. 1 is a perspective view of a brush head in accordance with an aspect of the present invention;

FIG. 2 is a right side view of the brush head;

FIG. 3 is a front view of the brush head;

FIG. 4 is a rear view of the brush head;

FIG. 5 is an exploded view of the brush head;

FIG. 5a is an exploded front view of the tuft blocks removed from the brush head for the sake of clarity;

FIG. 6 is a side view of the camshaft with the rest of the brush head removed for clarity; and showing the offsets in the camshaft;

FIG. 7 is a right side cross-sectional view of the brush head;

FIG. 8 is a cross-section taken along line 8-8 of FIG. 3 and showing a first tuft block disposed in its inward-most position relative to the head region;

FIG. 9 is a cross-section taken along line 8-8 of FIG. 3 and showing the first tuft block in its outer-most position relative to the head region;

FIG. 10 is a cross-section taken along line 10-10 of FIG. 3 showing a second tuft block tilted toward the left; and

FIG. 11 is a cross-section taken along line 10-10 of FIG. 3 showing the second tuft block tilted toward the right; and

FIG. 12 is a front view of the powered toothbrush incorporating the brush head of FIG. 1; with the handle and some of the components disposed within the brush head and handle shown in phantom.

Similar numbers refer to similar pads throughout the drawings.

### DETAILED DESCRIPTION

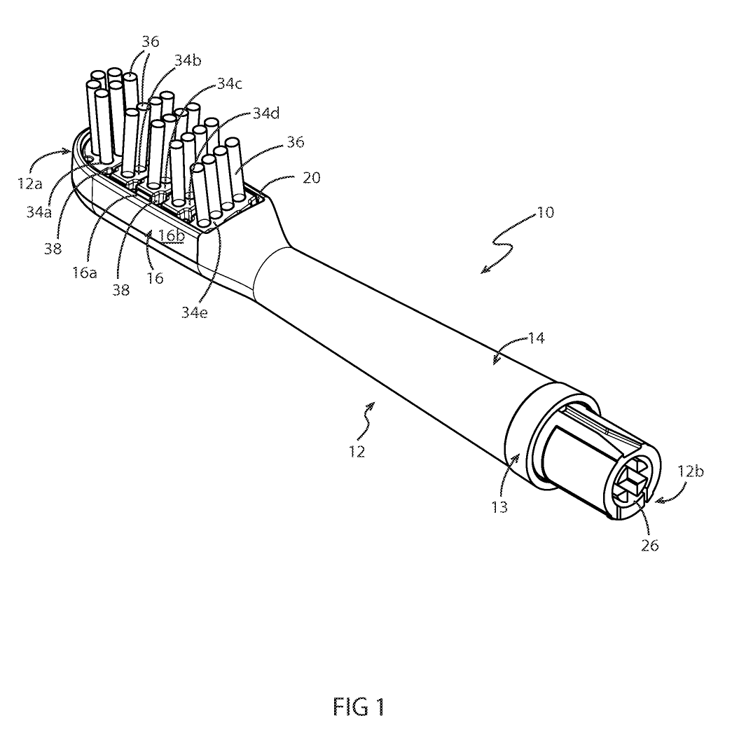

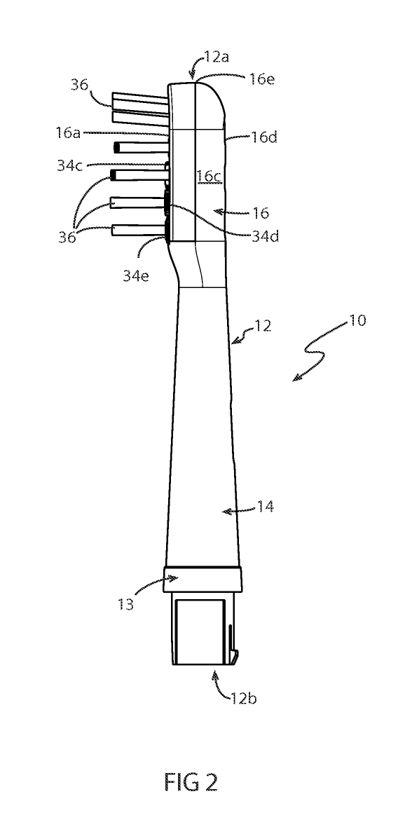

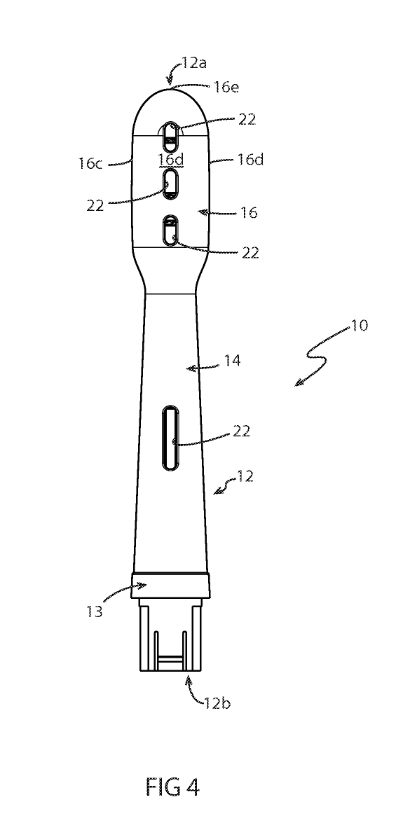

Referring to FIGS. 1-11, there is shown a brush head, generally indicated at 10 which is configured to be detachably engaged with a powered handle (not shown).

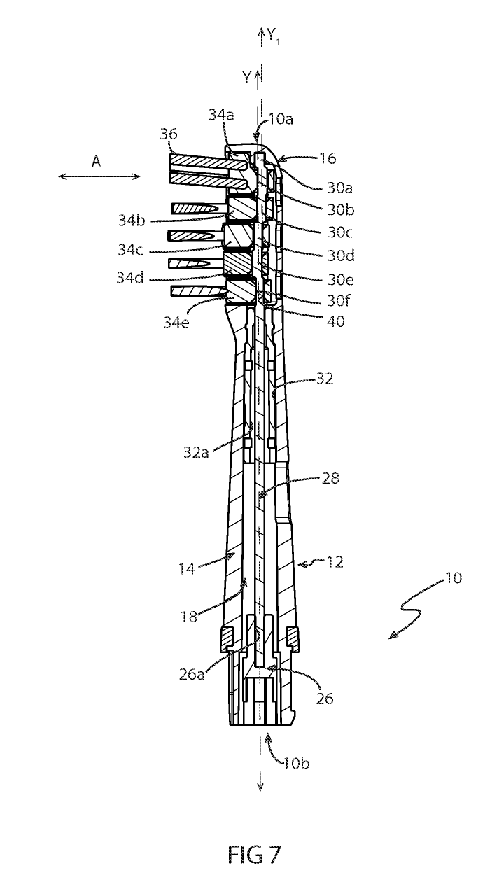

Brush head 10 comprises a housing 12 which has a first end 12a and a second end 12b. Housing 12 includes an elongate shaft 12 and a head 16 which preferably are integrally formed with each other. In particular, housing preferably 12 is an injection-molded plastic component. Shaft 14 is generally circular in cross-section and head 16 is generally U-shaped in cross-section (FIG. 7).

Head 16 of housing 12 includes a front face 16a, a first side 16b, a second side 16c, a rear face 16d, and an end wall 16e. Shaft 14 extends outwardly from a region of head 16 opposite end wall 16e. A cavity 18 is bounded and defined by the exterior wall of housing 12. Cavity 18 originates in an opening (not numbered) defined in the second end 12b of housing 12 and extends through shaft 14 and into head 16. Cavity 18 in head is bounded by front face 16a, first and second sides 16b, 16c, rear face 16d and end wall 16e. An opening 20 is defined in a front face 16a of head 16. Opening 20 is in communication with cavity 18. A series of apertures 22 are defined in a back surface of shaft 14 and rear face 16d of head 16. Apertures 22 are also in communication with cavity 18. Apertures 22 are provided to allow any water that may enter opening 20 to escape from brush head 10.

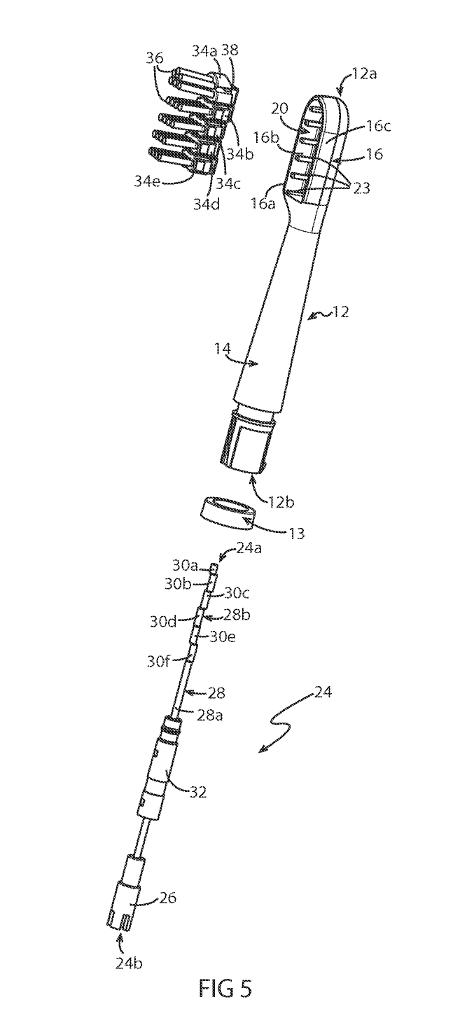

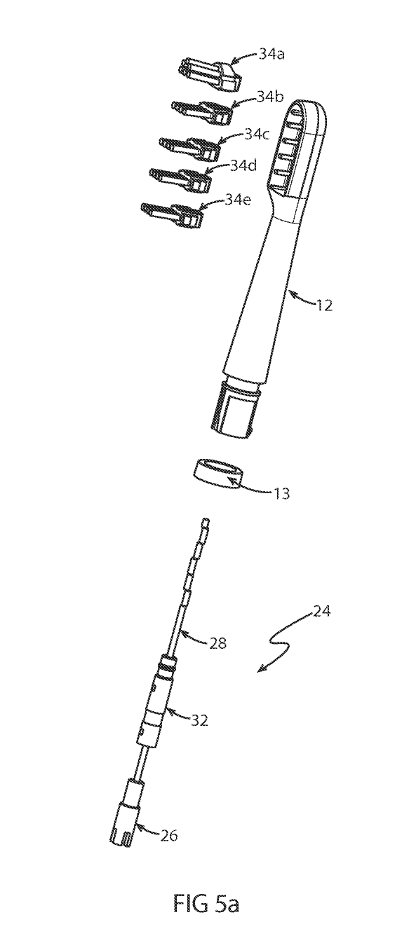

In accordance with an aspect of the present invention, a plurality of spaced-apart ridges 23 (FIG. 5) is provided in each of the interior surfaces of the opposed sides 16b, 16c of head 16. Ridges 23 are disposed aligned in pairs. In the particular embodiment illustrated herein, there are six aligned pairs of ridges 23 extending into cavity 18. The purpose of these ridges 23 will be discussed further herein.

Second end 12b of brush head 10 is configured to engage with a handle, as is known in the art.

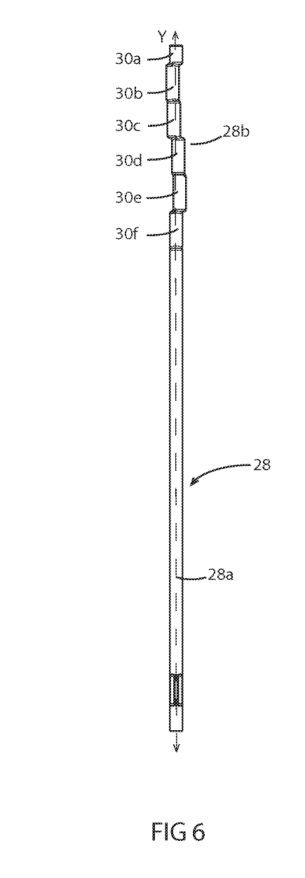

Brush head 10 further includes a drive shaft assembly 24 having a first end 24a and a second end 24b. A mounting member 26 is provided at second end 24a and is configured to engage a drive shaft (not shown) extending from a motor in a handle to which brush head 10 is engaged. Mounting member 26 may therefore take any configuration which is suitable for this purpose. Drive shaft assembly 24 further includes a camshaft 28 which extends through a bore 26a defined in mounting member 26 and extends outwardly and upwardly therefrom (with reference to FIG. 7). FIG. 6 shows camshaft 28 includes a first region 28a which is straight and a second region 28b which includes a plurality of off-set regions 30a, 30b, 30c, 30d, 30e, and 30f. The purpose of these off-set regions will be further described herein. A spacer 32 is provided and camshaft 28 extends through a bore 32a defined in spacer 32. Spacer 32 has an external diameter which is complementary to the diameter of cavity 18 in shaft 14. As best seen in FIGS. 5 and 7, spacer 32 tapers along its length and the taper matches the taper of cavity 18 defined in shaft 14. Spacer 32 keeps camshaft 28 centered within cavity 18. Camshaft 28 also includes a central longitudinal axis “Y”.

In accordance with another aspect of the invention, brush head 10 includes a plurality of separate tuft blocks 34a, 34b, 34c, 34d, and 34e which are each individually mounted within head 10 and are positioned adjacent each other. A plurality of bristle tufts 36 extend outwardly from a front face of each of the tuft blocks 34a-34e. Tuft blocks 34a-34e are mounted within cavity 18 such that bristle tufts 36 of all of the blocks extend outwardly from opening 20 in head 16. No portion of blocks 34a-34e extends through rear face 16d of head 16.

Each bristle tuft 36 is represented by one of the tubular member shown in the figures, however, it should be understood that each bristle tuft 36 preferably is comprised of a plurality of bristles. Each bristle tuft 36 has a longitudinal bristle axis that extends from front face 35a to a tip of the bristles in bristle tuft 36. It should be understood that instead of tuft block 34a-34e including a plurality of bristle tufts 36, they may instead include a plurality of flexible elastomeric fingers, or a combination of bristles and elastomeric fingers which are used to clean the surfaces of the teeth when brush head 10 is engaged with a powered handle. Obviously, if the power is not switched on, the brush head can still be used as a manual teeth cleaning implement, although this is not its preferred mode of operation. The term “bristle tuft” as used herein should therefore be given the broadest interpretation to represent of any flexible component which extends outwardly from head 16 and is brought into contact with the teeth to clean the same.

Tuft block 34a includes three rows of bristle tufts 36, with the uppermost row having one bristle tuft 36, the middle row having two bristle tufts 36, and the third and lowermost row having three bristle tufts 36. Each of tuft blocks 34b, 34c, 34d, and 34e includes a single row containing four bristle tufts 36.

As is best seen in FIG. 7, bristle tufts 36 extend outwardly from head 16 at an angle other than 90° relative to the front face of tuft block 34a. The bristle tufts 36 on all of the other tuft blocks 34b-34e are oriented so that the bristle tufts 36 are disposed at 90° relative to the front faces of those tuft blocks 34b-34e.

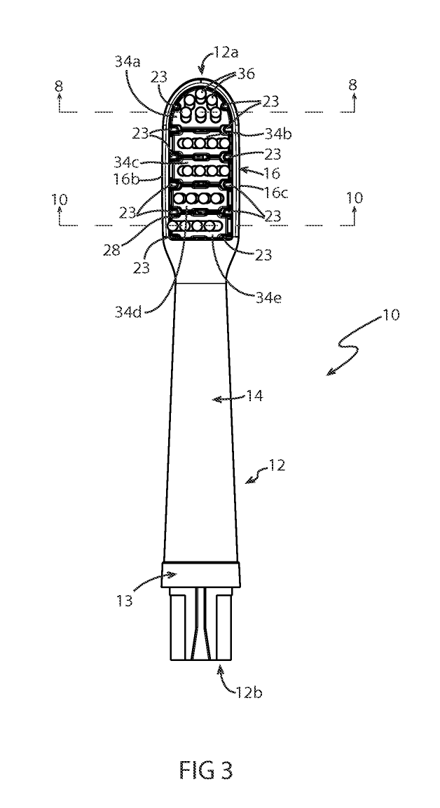

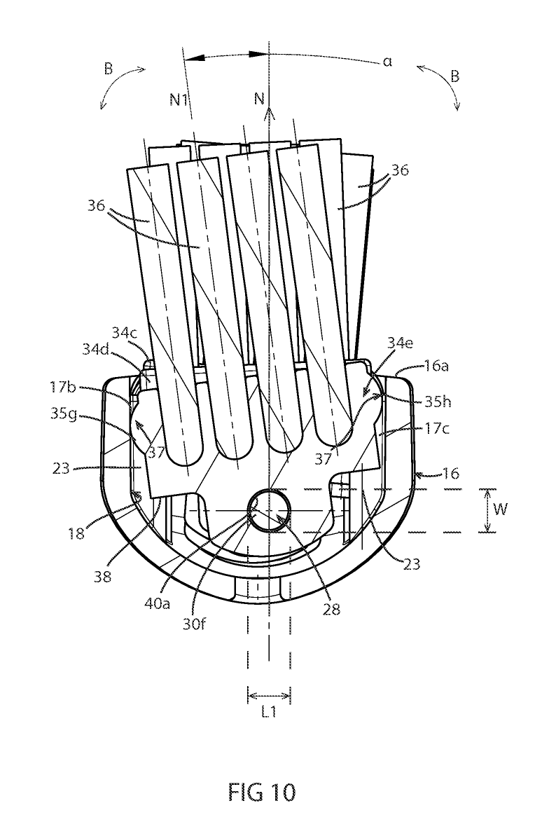

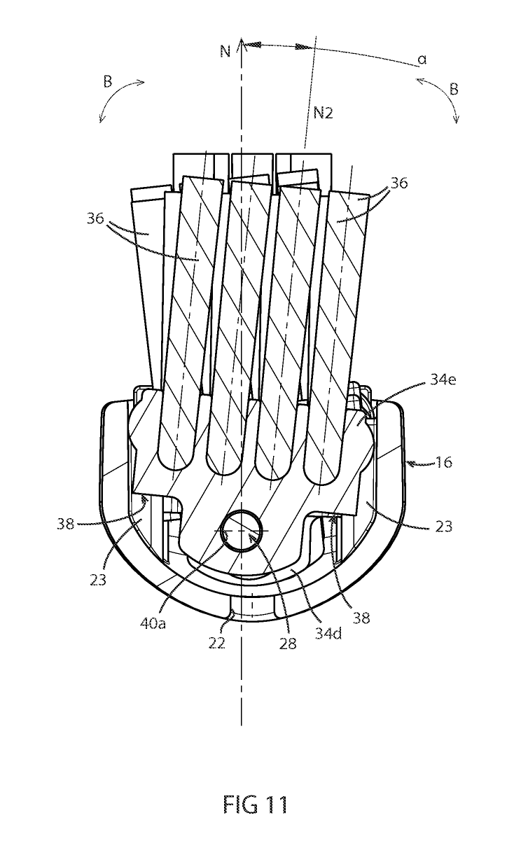

Each tuft block 34a-34e is mounted between aligned pairs of ridges 23 and the tuft blocks are specifically configured so that ridges 23 are seated in depressions 38 (FIGS. 1 and 3) formed along the upper and lower edges of the tuft block. Each tuft block 34a-34e further defines a hole 40 therein which extends between the upper and lower surfaces of the tuft block and substantially at right angles to depressions 38. The holes 40 are best seen in FIGS. 7-11. Camshaft 28 is generally circular in cross-section but the shape of the hole 40 in tuft block 34a differs from the shape of the hole in tuft blocks 34b-34e. The holes in tuft blocks 34b-34e will be referred to herein by the reference character 40a (FIGS. 10 and 11).

Hole 40 is an elongate aperture that is configured in like manner to the apertures disclosed in U.S. Pat. No. RE35,941, the entire specification of which is incorporated herein by reference. Hole 40 is elongated in a direction at right angles to the camshaft's longitudinal axis “Y”. Holes 40a in tuft blocks 34b-34e are generally circular of about the same diameter as camshaft 28.

As camshaft 28 rotates it causes the end tuft block, i.e., tuft block 34a to move in a back and forth motion into and out of opening 20 in front face 16a of head 16, i.e. linearly with respect to the bristle axis. This in-and-out motion is indicated by the arrow “A” in FIGS. 7-11. The motion of tuft block 34a is also oriented in a plane disposed at right angles relative to longitudinal axis “Y”.

The in-and-out motion of tuft block 34a is caused as camshaft 28 is rotated because of the shape and orientation of hole 40. Hole 40 extends horizontally and generally parallel to interior back surface 17a of head 16 and is of a length “L”. Hole 40 also has a width “W” which is smaller than length “L”. This configuration of hole 40 causes tuft block 34a to move in the back-and-forth motion indicated by arrow “A”.

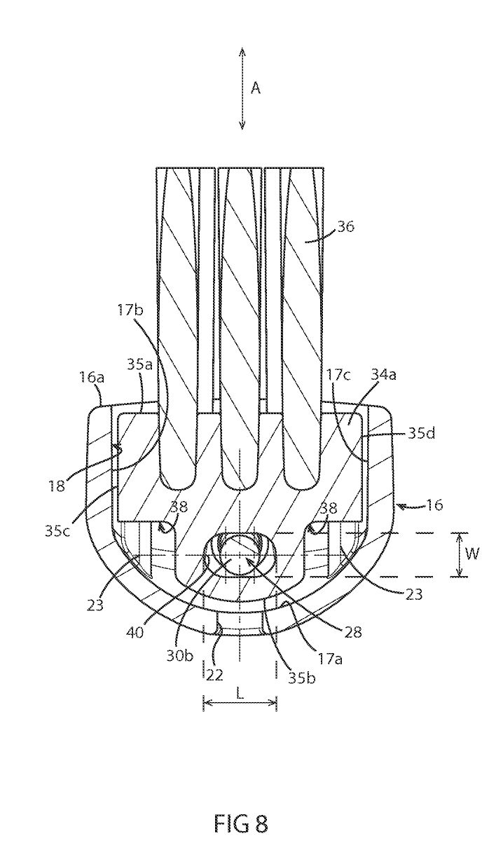

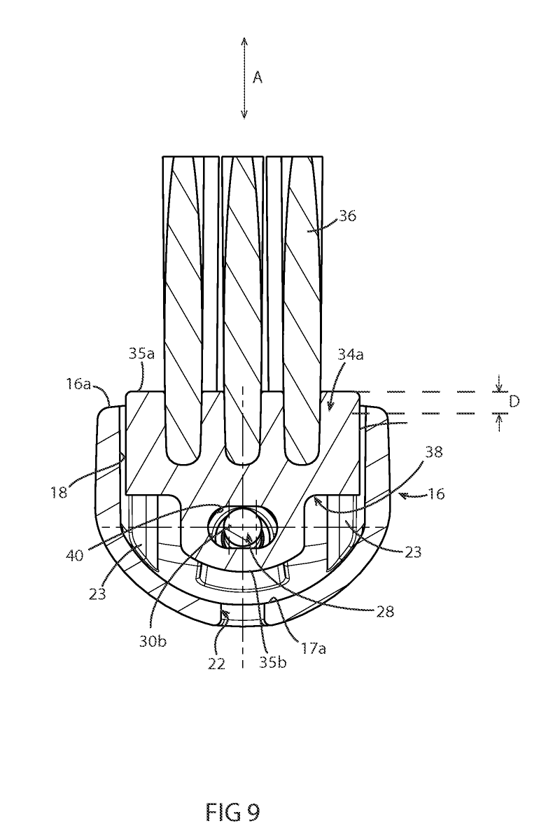

FIG. 8 shows the situation where camshaft 28 is in such a position within hole 40 in tuft block 34a that the front face 35a of tuft block 34a is disposed inwardly of front face 16a of head 16. At the same time, rear face 35b of tuft block 34a is disposed adjacent the interior rear surface 17a of head 16. FIG. 9 shows the situation where camshaft 28 has rotated within hole 40 and caused tuft block 34a to move a distance out of opening 18. Front face 35a of tuft block 34a is disposed outwardly of front face 16a of head 16 and rear face 35b of tuft block 34a is spaced a distance from the interior rear surface 17a of head 16. Front face 35a has thus been displaced through a distance “D” relative to the position shown in FIG. 8. It should be noted that the side faces 35c, 35d of tuft block 34a are disposed substantially parallel to the interior sides surface 17b, 17c of head 16 at all times during this in-and-out, linear motion.

FIGS. 10 and 11 show tuft block 34e, its relationship to camshaft 28 and the motion caused therein as camshaft rotates. In tuft block 34e, the width “W” and length “L1” of hole 40a are substantially the same. More particularly, the width and length are only slightly larger than the diameter of camshaft 28. This configuration of hole 40a causes a different motion in tuft block 34e, provided there is an offset in the section of the camshaft 28 which passes through hole 40a. In the instance shown in FIGS. 10 and 11, the section 30f of camshaft 28 passes through tuft block 34e and this section 30f is offset relative to the rest 28a of camshaft 28. Additionally each of the side surfaces 35g, 35h of tuft block 34e includes a protuberance 37 which extends outwardly for a distance beyond the rest of the associated side surface 35g, 35h. These protuberances 37 are semi-spherical in shape and they are able to ride on interior side surfaces 17b, 17c of head 16. As camshaft 28 rotates about the longitudinal axis “Y”, tuft block 34e is caused to tilt from side-to-side in a motion that is indicated by arrow “B”. The angular displacement between the initial, at rest position (identified by the reference character “N”), and a first position adjacent the left side surface 17b of head 16 (identified by the reference character “N2”) is an angle α. Preferably, angle α is about 6° in a first direction. The displacement between the at rest position “N” and a second position adjacent the right side surface 17c (identified by the reference character “N3”) is about again an angle α, and once again, that angle α preferably is about 6° in a second direction. Thus tuft block 34e tilts from side-to-side and thus bristle tufts 36 sweep back and forth through an arc of about 12°.

Tuft blocks 34b, 34c and 34d are similarly configured to tuft block 34e. The differently offset portions 30c, 30d, 30e, and 30f of the camshaft 28, each of which extends through a hole 40a defined in the associated one of tuft blocks 34b, 34c, 34d and 34e; causes the tuft blocks 34b-34e to tilt or sweep at different times and to varying degrees relative to tuft block 34e. Thus, as is evident from FIGS. 10 and 11, the bristles associated with the various tuft blocks 34b, 34c, 34d and 34e are out of synchrony with each other. Each of the tuft blocks 34b, 34c, and 34d oscillate about an axis that extends through that portion of camshaft 28 which engages the particular tuft blocks 34b-34d. In each case, the axis about which the tuft block oscillates is substantially parallel to camshaft's longitudinal axis “Y”.

It will be understood that if the section of camshaft 28 which passes through any of tuft blocks 34a, 34b, 34c, 34d, or 34e is aligned in the same plane as the section 28a, then when camshaft 28 rotates, that section of camshaft 28 will rotate within hole 40, 40a in the associated tuft block but no motion will be imparted to the associated tuft block—i.e., that associated tuft block will not move. It will therefore be possible to provide a brush head which includes a first tuft block which moves into-and-out of the opening 20 in head 16 as camshaft 28 rotates, along with a second tuft block that tilts back and forth; and a third tuft block which is substantially motionless. Any combination of these three tuft blocks 36 may be provided on brush head 10. In the instance of any tuft block provided which is to remain motionless during operation, i.e. not moving in-and-out or tilting back-and-forth, that motionless tuft block can be of any shape and include any number of tufts of bristles positioned in any desired configuration; including having the appearance of tuft block 34a or 34b-34e; or a block of the overall shape and size of tuft blocks 34b-34e but which lacks the protuberances 37 or is of the shape of tuft block 34a and includes protuberances on the side surfaces.

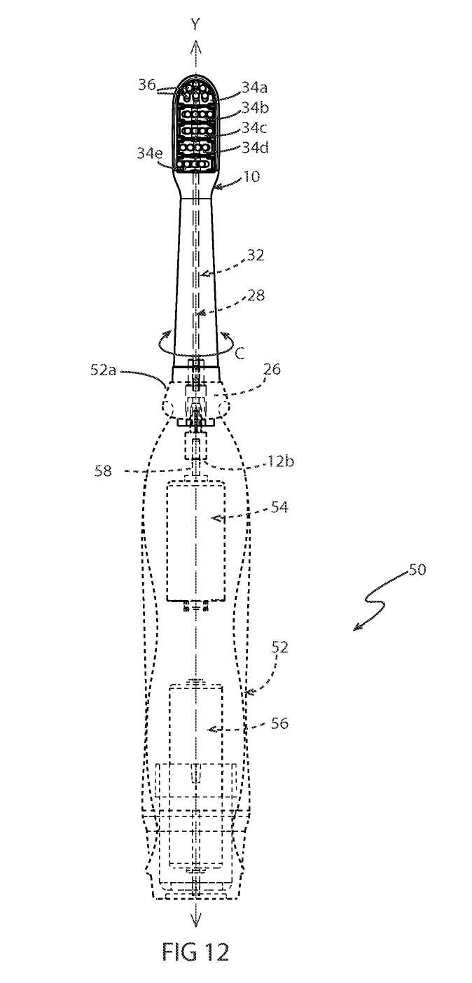

FIG. 12 shows a toothbrush incorporating the brush head 10 shown in FIGS. 1-11, with the toothbrush being generally indicated by the reference number 50. Toothbrush 50 includes a handle 52 with which brush head 10 is detachably engageable. A motor 54 and power source 56 are disposed within an interior of handle 52 and are operatively engaged with each other. A drive shaft 56 extends outwardly from motor 54 and is operatively engaged with camshaft 28. When drive shaft 56 rotates it will in turn rotate camshaft 28. The motion of camshaft 28 will be transmitted to tuft blocks 34a-34e as previously described herein.

Toothbrush 50 thus comprises:

a handle 52; and

a brush head 10, where the brush head 10 comprises:
a housing having a head region 16 and a shaft region 14, wherein the shaft region 14 terminates in a free end 12b configured to be secured to an end 52a of the handle 52;
a cavity (not numbered in FIG. 12) originates in free end 12b of the shaft region 14, said cavity extending inwardly into the head region 16;
an opening (not shown) defined in a front face of the head region 16 is in communication with the cavity;
a camshaft 28 extending through an aperture (not shown in FIG. 12) and into the cavity along a camshaft longitudinal axis “Y”; wherein said camshaft 28 is operatively engaged with a drive shaft 58 driven by a motor 54 disposed within the handle 50;
a first and second tuft block 34a, 34b provided on the head region and operatively engaged with the camshaft 28 and being independently movable by the camshaft; and
at least one bristle tuft 36 extending outwardly from a face of each of the first and second blocks 34a, 34b and extending outwardly of the opening in the head region 16; and wherein the first tuft block 34a is caused to reciprocate linearly in a plane disposed at right angles to the longitudinal axis “Y”, and the second tuft block 34b is caused to oscillate (i.e., tilt toward the left as shown in FIG. 10, then tilt toward the right as shown in FIG. 11, and then tilt back toward the left, and so on) about an axis “Y1” (FIG. 7) disposed substantially parallel to the longitudinal axis “Y”.

In another aspect the invention provides a method of removing food matter and/or plaque from teeth; said method including:
providing a toothbrush 50 having a brush head 10 comprising a housing 12 with a head region 16 and a shaft region 14, a camshaft 28 extending through a cavity (not numbered) defined in the housing 12 and operatively engaged with a drive shaft 58 driven by a motor 54 in a handle 52 of the toothbrush 50; a first and second tuft block 34a, 34b provided on the head region 16 and being operatively engaged with the camshaft 28, and at least one bristle tuft 36 extending outwardly from a face of each of the first and second tuft blocks 34a, 34b;
rotating the camshaft about a longitudinal axis “Y” (as indicated by arrow “C” in FIG. 12);
linearly reciprocating the first tuft block 34a in a plane disposed at right angles to the camshaft's longitudinal axis “Y”; and
oscillating the second tuft block 34b about an axis “Y1” (FIG. 7) disposed substantially parallel to the camshaft's longitudinal axis “V”.

The method further includes chiseling food matter and/or plaque from the surface of the teeth when engaged by the bristle tufts 36 provided on first tuft block 34a; and sweeping food matter and/or plaque from the surface of the teeth when engaged by the bristle tufts 36 provided on second tuft block 34b. Since tuft blocks 34c-34e are similarly configured to second tuft block 34b, it will be understood that the bristle tufts 36 provided on blocks 34c, 34e remove food matter and/or plaque from teeth surfaces in a similar manner to second tuft block 34b.

It will be understood that some of the tuft blocks 34c, 34e which currently are shown configured in a similar manner to tuft block 34b could, instead, be configured in a manner similar to tuft block 34a and remove food matter and/or plaque in a similar manner to the same. Additionally or alternatively, some of the tuft blocks 34c-34e could be engaged so that they will remain substantially stationary when camshaft 28 is rotated.

The combination of movements in the tuft blocks 34a-34e helps to more effectively remove food material and/or plaque from the surface of the teeth and the interdental spaces as first tuft block 34a chisels away food material that is lodged adjacent the gingiva or in the interdental spaces, as well as chiseling away plaque or food material that is effectively bonded to the surface of the teeth. The sweeping or wiping motion of the bristle tufts 36 on tuft blocks 34b, 34e aids is removing the material which has been chiseled away by bristles 36 on first tuft block 34a. The ensures that the chiseling motion of first tuft block 34a continuously comes into contact with materials that remain lodged on the teeth surfaces instead of simply contact material that has already been chiseled away but not removed. Consequently, toothbrush 50 tends to be more effective at cleaning the teeth and keeping them substantially plaque free.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A brush head for engagement with a handle of a powered toothbrush, said brush head comprising:
a housing having a head region and a shaft region, wherein the shaft region is adapted to be engaged with the handle;
a cavity defined in the housing and extending inwardly from an opening defined in a free end of the shaft region and into the head region;
an opening defined in a front face of the head region, said opening being in communication with the cavity;
a camshaft extending through the cavity along a longitudinal axis; said camshaft being adapted to be operatively engaged with a drive shaft extending from a motor disposed within the handle;
a first tuft block and a second tuft block, each in the head region and being operatively engaged with the camshaft; and
at least one bristle tuft extending outwardly from each of the first and second tuft blocks and through the opening in the head region; and upon rotation of the camshaft, the first tuft block is caused to reciprocate linearly in a plane disposed at right angles to the longitudinal axis; and the second tuft block is caused to oscillate about an axis parallel to the longitudinal axis.

2. The brush head as defined in claim 1, wherein the first and second tuft blocks move independently of each other upon rotation of the camshaft.

3. The brush head as defined in claim 2, wherein motion in the first tuft block is sequentially followed by motion in the second tuft block.

4. The brush head as defined in claim 2, further comprising a third tuft block provided on the head region, with at least one bristle tuft disposed thereon, said third tuft block being disposed adjacent one or both of the first and second tuft blocks; said third tuft block being operatively engaged with the camshaft; and wherein the at least one bristle tuft on the third tuft block extends outwardly through the opening in the head region

5. The brush head as defined in claim 4, wherein the third tuft block oscillates about the axis disposed parallel to the longitudinal axis in response to motion in the camshaft.

6. The brush head as defined in claim 5, wherein the oscillation of the third tuft block is out of synchrony with the oscillation of the first tuft block.

7. The brush head as defined in claim 5, wherein the oscillation of the third tuft block occurs sequentially before or after the oscillation of the first tuft block.

8. The brush head as defined in claim 5, further comprising an additional tuft block with at least one bristle tuft disposed thereon, said additional tuft block being on the head region of the brush head adjacent one or more of the first, second or third tuft blocks; said additional tuft block being operatively engaged with the camshaft; and wherein the at least one bristle tuft on the additional tuft block extends outwardly through the opening defined in the head region of the brush head.

9. The brush head as defined in claim 8, wherein the additional tuft block oscillates about the axis disposed parallel to the longitudinal axis in response to motion in the camshaft.

10. The brush head as defined in claim 9, wherein the oscillation of the additional tuft block is out of synchrony with the oscillation of one or both of the first and third tuft blocks.

11. The brush head as defined in claim 9, wherein the oscillation of the additional tuft block occurs sequentially before or after the oscillation of either of the first and third tuft blocks.

12. The brush head as defined in claim 1, wherein the at least one bristle tuft on the first tuft block is disposed at an angle of substantially 90° relative to the front face of the first tuft block; and the at least one bristle tuft on the second tuft block is disposed at an angle other than 90° relative to the front face of the second tuft block

13. The brush head as defined in claim 1, wherein the second tuft block includes a pair of side walls which extend rearwardly from a front face thereof; wherein the at least one bristle tuft extends outwardly from this second tuft block front face; and wherein each of the side walls includes arcuate protuberances which project outwardly toward an associated one of a first and second side wall of the head region which defines the opening.

14. The brush head as defined in claim 1, wherein the camshaft includes a first section that is aligned along the longitudinal axis; a second section that is offset relative to the longitudinal axis; and a third section that is offset relative to each of the first and second sections; and wherein each of the first and second tuft blocks defines a hole therein; and the second section of the camshaft is received through the hole in the first tuft block and the third section of the camshaft is received through the hole in the second tuft block.

15. The brush head as defined in claim 14, wherein the camshaft is circular in cross-section; and the hole defined in the second tuft block is circular in shape and complementary to the camshaft.

16. The brush head as defined in claim 14, wherein the camshaft is circular in cross-section and the hole in the first tuft block is not circular in shape but is instead elongate in a plane parallel to the longitudinal axis.

17. The brush head as defined in claim 1, wherein the second tuft block oscillates through about 12 degrees.

18. The brush head as defined in claim 1, further comprising a third tuft block disposed within the cavity in the head region and including at least one bristle tuft extending outwardly from a front face of the third tuft block; wherein the third tuft block is operatively engaged with a section of the camshaft that is aligned with the longitudinal axis; and wherein the third tuft block remains substantially stationary when the camshaft rotates.

19. A powered toothbrush comprising:
a handle; and
a brush head comprising:
a housing having a head region and a shaft region, wherein the shaft region terminates in a free end configured to be secured to an end of the handle;
a cavity originating in an aperture defined in the free end of the shaft region, said cavity extending inwardly into the head region;
an opening defined in a front face of the head region, said opening being in communication with the cavity;
a camshaft extending through the aperture and into the cavity along a longitudinal axis; wherein said camshaft is adapted to be operatively engaged with a drive shaft driven by a motor disposed within the handle;
a first and second tuft block provided on the head region and operatively engaged with the camshaft and being independently movable by the camshaft;
at least one bristle tuft extending outwardly from a face of each of the first and second blocks and extending outwardly of an opening in the head region; and wherein the first tuft block is caused to reciprocate linearly in a plane disposed at right angles to the longitudinal axis; and the second tuft block is caused to oscillate about an axis parallel to the longitudinal axis.

20. A method of removing food matter and/or plaque from teeth; said method including:
providing a toothbrush having a brush head comprising a housing with a head region and a shaft region, a camshaft extending through a cavity defined in the housing and operatively engaged with a drive shaft driven by a motor in a handle of the toothbrush; a first and second tuft block provided on the head region and being operatively engaged with the camshaft, and at least one bristle tuft extending outwardly from a face of each of the first and second tuft blocks;
rotating the camshaft about a longitudinal axis;
linearly reciprocating the first tuft block in a plane disposed at right angles to the camshaft's longitudinal axis; and
oscillating the first tuft block about an axis disposed substantially parallel to the camshaft's longitudinal axis.

21. The method as defined in claim 20, further comprising the steps of:
chiseling particulate material from surfaces of teeth using the one or more bristle tufts on the first tuft block and
sweeping particulate material from surfaces of teeth using the one or more bristle tufts on the second tuft block.
